(19) United States
(12) Patent Application Publication
(10) Pub. No.: US 2004/0190754 A1
(43) Pub. Date: Sep. 30, 2004

(54) Image transmission system for a mobile robot

(75) Inventors: Yoshiaki Sakagami, Wako (JP); Koji Kawabe, Wako (JP); Nobuo Higaki, Wako (JP); Naoaki Sumida, Wako (JP); Takahiro Oohashi, Wako (JP); Youko Saitou, Wako (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Honda Motor Co., Ltd.

(21) Appl. No.: 10/814,344

(22) Filed: Apr. 1, 2004

(30) Foreign Application Priority Data
Mar. 31, 2003 (JP) 2003-094166

(51) Int. Cl. G06K 9/00; H04N 7/18

(52) U.S. Cl. 382/103; 382/181; 348/143

(57) ABSTRACT

In an image transmission system for a mobile robot that can move about and look for persons such as children separated from their parents in places where a large number of people congregate, a face image is cut out from a captured image of a detected human, and the cut out face image is transmitted to a remote terminal or a large screen. By thus cutting out the image of the face, even when the image signal is transmitted to a remote terminal having a small screen, the face image can be shown in a clearly recognizable manner. Also when the image is shown in a large screen, the viewer can identify the person even from a great distance. The transmitted image may be attached with various pieces of information such as the current location of the robot.

### TECHNICAL FIELD

The present invention relates to an image transmission system for a mobile robot.

### BACKGROUND OF THE INVENTION

It is known to equip a robot with a camera to monitor a prescribed location or a person and transmit the obtained image data to an operator (See Japanese patent laid open publication No. 2002-261966, for instance). It is also known to remote control a robot from a portable terminal (See Japanese patent laid open publication No. 2002-321180, for instance).

If a mobile robot is given with a function to spot a person and transmit an image of the person, it becomes possible to monitor the image of the person who may move about by using such a mobile robot. However, the aforementioned conventional robots are only capable of carrying out a programmed task in connection with a fixed location, and can respond only to a set of highly simple commands. Therefore, such conventional robots are not capable of spotting a person who may move about and transmit the image of such a person.

### BRIEF SUMMARY OF THE INVENTION

In view of such problems of the prior art, a primary object of the present invention is to provide a mobile robot that can locate or identify an object such as a person, and transmit the image of the object or person to a remote terminal.

A second object of the present invention is to provide a mobile robot that can autonomously detect a human and transmit the image of the person or in particular the face image of the person.

A third object of the present invention is to provide a mobile robot that can accomplish the task of finding children who are separated from their parents in a crowded place, and help their parents reunite with their children.

According to the present invention, such objects can be accomplished by providing an image transmission system for a mobile robot, comprising: a camera for capturing an image as an image signal; human detecting means for detecting a human from the captured image; a power drive unit for moving the robot toward the detected human; face identifying means for identifying a position of a face of the detected human; face image cut out means for cutting out a face image from the captured image of the detected human; and image transmitting means for transmitting the cut out face image to an external terminal.

By thus cutting out the image of the face, even when the image signal is transmitted to a remote terminal having a small screen, the face image can be shown in a clearly recognizable manner. Also when the image is shown in a large screen, the viewer can identify the person even from a great distance. If the system further comprises means for monitoring state variables including the current position of the robot, the image transmitting means may transmit monitored state variables in addition to the cut out face image to aid the viewer to locate and meet the person whose face image is being shown.

If the system further comprises a face database that stores images of a plurality of faces and face identifying means for comparing the cut out face image with the faces stored in the face database to identify the cut out face image, the system is enabled to identify the person automatically.

The face of the detected person can be identified in various ways. For instance, if the face identifying means comprises means for detecting an outline of the detected human, the face may be identified as an area defined under an upper part of the outline of the detected human.

It is important to distinguish between still objects and humans. For this purpose, the human detecting means may be adapted to detect a human as a moving object that changes in position from one frame of the image to another.

The mobile robot of the present invention is particularly useful as a tool for finding and looking after children who are separated from their parents in places where a large number of people congregate.

### BRIEF DESCRIPTION OF THE DRAWINGS

Now the present invention is described in the following with reference to the appended drawings, in which:

FIG. 1 is an overall block diagram of the system embodying the present invention;

FIG. 2 is a flowchart showing a control mode according to the present invention;

FIG. 3 is a flowchart showing an exemplary process for speech recognition;

FIG. 4a is a view showing an exemplary moving object that is captured by the camera of the mobile robot;

FIG. 4b is a view similar to FIG. 4a showing another example of a moving object;

FIG. 5 is a flowchart showing an exemplary process for outline extraction;

FIG. 6 is a flowchart showing an exemplary process for cutting out a face image;

FIG. 7a is a view of a captured image when a human is detected;

FIG. 7b is a view showing a human outline extracted from the captured image;

FIG. 8 is a view showing a mode of extracting the eyes from the face;

FIG. 9 is a view showing an exemplary image for transmission;

FIG. 10 is a view showing an exemplary process of recognizing a human from his or her gesture or posture;

FIG. 11 is a flowchart showing the process of detecting a child who has been separated from its parent;

FIG. 12a is a view showing how various characteristics are extracted from the separated child; and

FIG. 12b is a view showing a transmission image of a child separated from its parent.

### DETAILED DESCRIPTION OF THE PREFERRED EMBODIMENTS

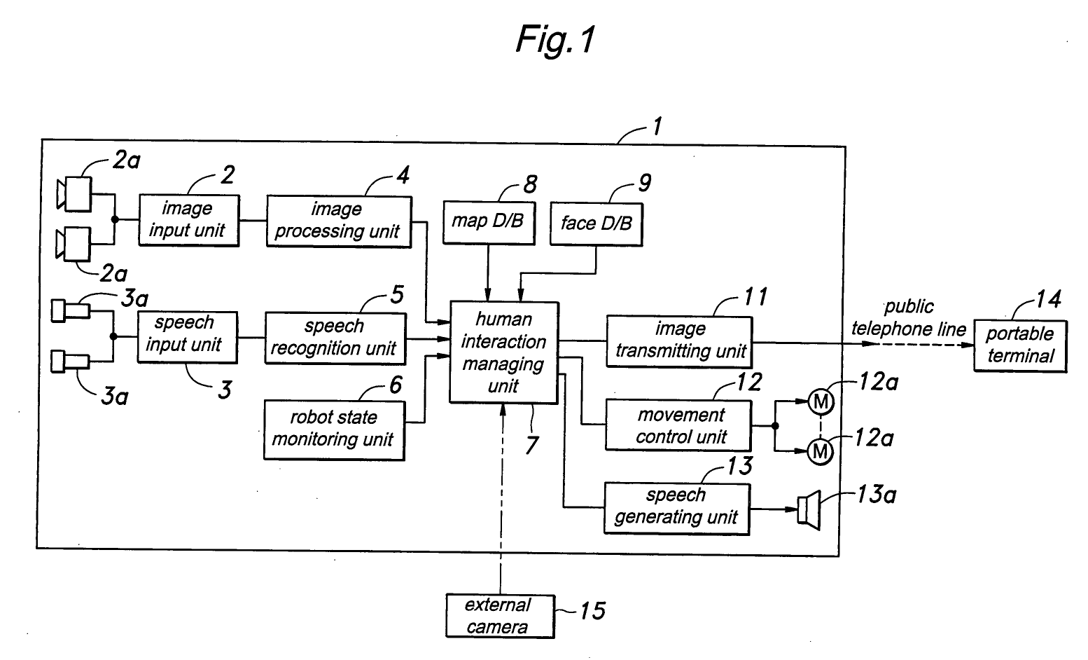

FIG. 1 is an overall block diagram of a system embodying the present invention. The illustrated embodiment uses a mobile robot 1 that is bipedal, but it is not important how the robot is able to move about, and a crawler and other modes of mobility can also be used depending on the particular application. The mobile robot 1 comprises an image input unit 2, a speech input unit 3, an image processing unit 4 connected to the image input unit 2 for cutting out a desired part of the obtained image, a speech recognition unit 5 connected to the speech input unit 3, a robot state monitoring unit 6 for monitoring the state variables of the robot 1, a human response managing unit 7 that receives signals from the image processing unit 4, speech recognition unit 5 and robot state monitoring unit 6, a map database unit 8 and face database unit 9 that are connected to the human response managing unit 7, an image transmitting unit 11 for transmitting image data to a prescribed remote terminal according to the image output information from the human response managing unit 7, a movement control unit 12 and a speech generating unit 13. The image input unit 2 is connected to a pair of cameras 2a that are arranged on the right and left sides. The speech input unit 3 is connected to a pair of microphones 3a that are arranged on the right and left sides. The image input unit 2, speech input unit 3, image processing unit 4 and speech recognition unit 5 jointly form a human detection unit. The speech generating unit 13 is connected to a sound emitter in the form of a loudspeaker 13a. The movement control unit 12 is connected to a plurality of electric motors 12a that are provided in various parts of the bipedal mobile robot 1 such as various articulating parts thereof.

The output signal from the image transmitting unit 11 may consist of a radio wave signal or other signals that can be transmitted to a portable remote terminal 14 via public cellular telephone lines or dedicated wireless communication lines. The mobile robot 1 may be equipped with a camera or may hold a camera so that the camera may be directed to a desired object and the obtained image data may be forwarded to the human response managing unit 7. Such a camera is typically provided with a higher resolution that the aforementioned cameras 2a.

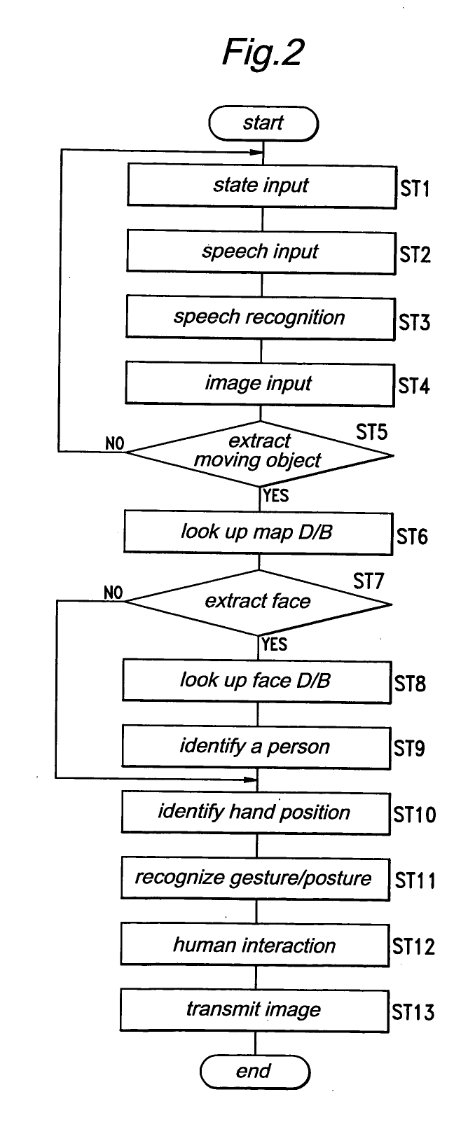

The control process for the transmission of image data by the mobile robot 1 is described in the following with reference to the flowchart of FIG. 2. First of all, the state variables of the robot detected by the robot state monitoring unit 6 is forwarded to the human response managing unit 7 in step ST1. The state variables of the mobile robot 1 may include the global location of the robot, direction of movement and charged state of the battery. Such state variables can be detected by using sensors that are placed in appropriate parts of the robot, and are forwarded to the robot state monitoring unit 6.

The sound captured by the microphones 3a placed on either side of the head of the robot is forwarded to the speech input unit 3 in step ST2. The speech recognition unit 5 performs a speech analysis process on the sound data forwarded from the speech input unit 3 using the direction and volume of the sound in step ST3. The sound may consist of a human speech or a crying of a child as the case may be. The speech recognition unit 5 can estimate the location of the source of the sound according to the difference in the sound pressure level and arrival time of the sound between the two microphones 3a. The speech recognition unit 5 can also determine if the sound is an impact sound or speech from the rise rate of the sound level and recognize the contents of the speech by looking up the vocabulary that is stored in a storage unit of the robot in advance.

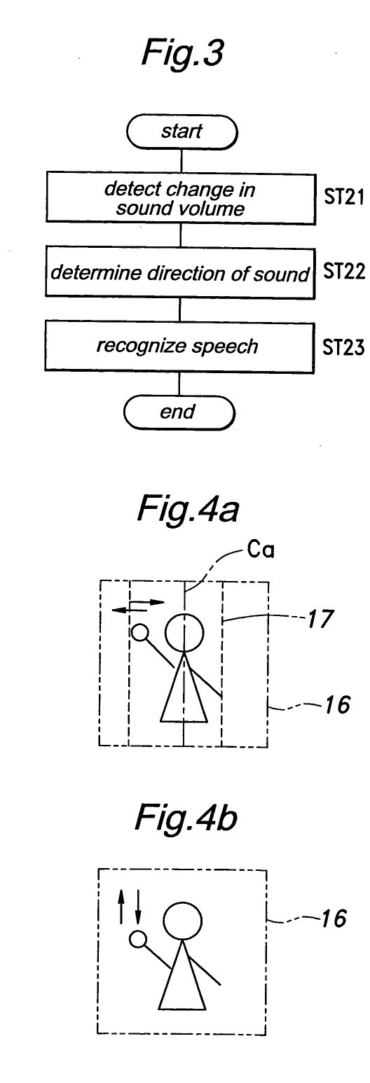

An exemplary process of speech recognition in step ST3 is described in the following with reference to the flowchart shown in FIG. 3. This control flow may be executed as a subroutine of step ST3. When a robot is addressed by a human, it can be detected as a change in the sound volume. For such a purpose, the change in the sound volume is detected in step ST21. The location of the source of the sound is determined in step ST22. It can be accomplished by detecting a time difference and/or a difference in sound pressure between the sounds detected by the right and left microphones 3a. A speech recognition is carried out in step ST23. This can be accomplished by using such known techniques as separation of sound elements and template matching. The kinds of the speech may include “hello” and “come here”. If the separated sound element when a change in the sound volume has occurred does not correspond to any of those included in the vocabulary or no match with any of the words included in the template can be found, the sound is determined as not being a speech.

Once the speech processing subroutine has been finished, the image captured by the cameras 2a placed on either side of the head is forwarded to the image input unit 2 in step ST4. Each camera 2a may consist of a CCD camera, and the image is digitized by a frame grabber to be forwarded to the imaging processing unit 4. The image processing unit 4 extracts a moving object in step ST5.

The process of extracting a moving object in step ST5 is described in the following taking an example illustrated in FIGS. 4a and 4b. The cameras 2a are directed to the direction of the sound source recognized by the speech recognition process. If no speech is recognized, the head is turned in either direction until a moving object such as those illustrated in FIGS. 4a and 4b is detected, and the moving object is then extracted. FIG. 4a shows a person waving his hand who is captured within a certain viewing angle of the cameras 2a. FIG. 4b shows a person moving his hand back and forth to beckon somebody. In such cases, the person moving his hand is recognized as a moving object.

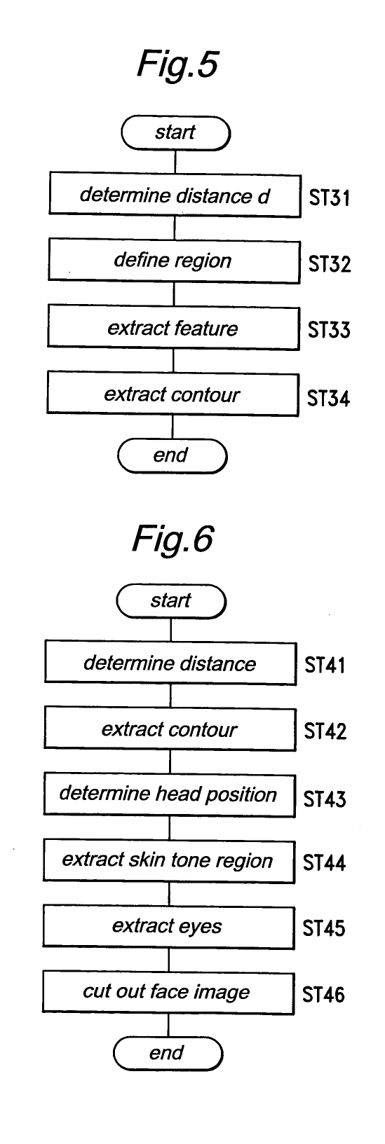

The flowchart of FIG. 5 illustrates an example of how this process of extracting a moving object can be carried out as a subroutine process. The distance d to the captured object is measured by using stereoscopy in step ST31. The reference points for this measurement can be found in the parts containing a relatively large number of edge points that are in motion. In this case, the outline of the moving object is extracted by a method of dynamic outline extraction using the edge information of the captured image, and the moving object can be detected from the difference between two frames of the captured moving image that are either consecutive to each other or spaced from each other by a number of frames.

A region for seeking a moving object is defined within a viewing angle 16 in step ST32. A region (d+Δd) is defined with respect to the distance d, and pixels located within this region are extracted. The number of pixels are counted along each of a number of vertical axial lines that are arranged laterally at a regular interval in FIG. 4a, and the vertical axial line containing the largest number of pixels is defined as a center line Ca of the region for seeking a moving object. A width corresponding to a typically shoulder width of a person is computed on either side of the center line Ca, and the lateral limit of the region is defined according to the computed width. A region 17 for seeking a moving object defined as described above is indicated by dotted lines in FIG. 4a.

Characteristic features are extracted in step ST33. This process may consist of seeking a specific marking or other features by pattern matching. For instance, an insignia that can be readily recognized may be attached to the person who is expected to interact with the robot in advance so that this person may be readily tracked. A number of patterns of hand movement may be stored in the system so that the person may be identified from the way he moves his hand when he is spotted by the robot.

The outline of the moving object is extracted in step ST34. There are a number of known methods for extracting an object (such as a moving object) from given image information. The method of dividing the region based on the clustering of the characteristic quantities of pixels, outline extracting method based on the connecting of detected edges, and dynamic outline model method (snakes) based on the deformation of a closed curve so as to minimize a pre-defined energy are among such methods. An outline is extracted from the difference in brightness between the object and background, and a center of gravity of the moving object is computed from the positions of the points on or inside the extracted outline of the moving object. Thereby, the direction (angle) of the moving object with respect to the reference line extending straight ahead from the robot can be obtained. The distance to the moving object is then computed once again from the distance information of each pixel of the moving object whose outline has been extracted, and the position of the moving object in the actual space is determined. When there are more than one moving object within the viewing angle, a corresponding number of regions are defined so that the characteristic features may be extracted from each region.

When a moving object was not detected in step ST5, the program flow returns to step ST1. Upon completion of the subroutine for extracting a moving object, a map database stored in the map database unit 8 is looked up in step ST6 so that the existence of any restricted area may be identified in addition to determining the current location and identifying a region for image processing.

In step ST7, a small area in an upper part of the detected moving object is assumed as a face, and color information (skin color) is extracted from this area considered to be a face. If a skin color is extracted, the location of the face is determined, and the face is extracted.

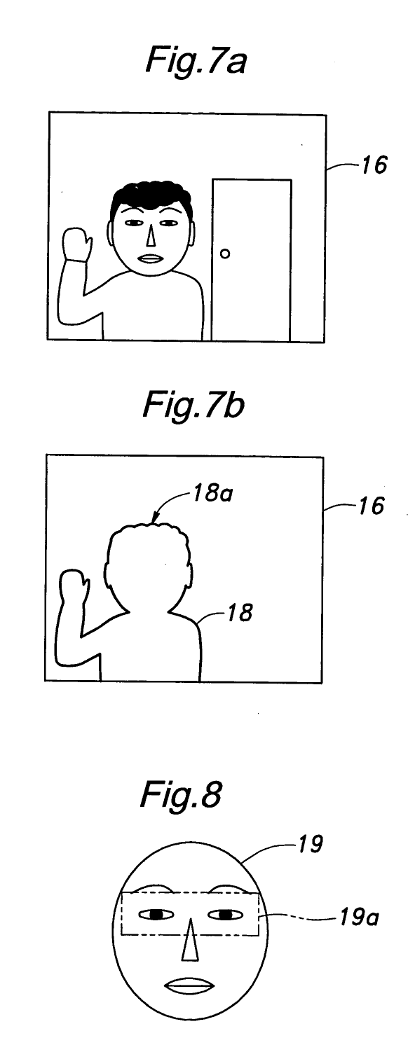

FIG. 6 is a flowchart illustrating an exemplary process of extracting a face in the form of a subroutine process. FIG. 7a shows an initial screen showing the image captured by the cameras 2a. The distance is detected in step ST41. This process may be similar to that of step ST31. The outline of the moving object in the image is extracted in step ST42 similarly as the process of step ST34. The steps 41 and 42 may be omitted when the data acquired in steps ST32 and 34 is used.

If an outline 18 as illustrated in FIG. 7b is extracted in step ST43, the uppermost part of the outline 18 in the screen is determined as a top of a head 18a. This information may be used by the image processing unit 4 as a means for identifying the position of the face. An area of search is defined by using the top of the head 18a as a reference point. The area of search is defined as an area corresponding to the size of a face that depends on the distance to the object similarly as in step ST32. The depth is also determined by considering the size of the face.

The skin color is then extracted in step ST44. The skin color region can be extracted by performing a thresholding process in the HLS (color phase, lightness and color saturation) space. The position of the face can be determined as a center of gravity of the skin color area within the search area. The processing area for a face which is assumed to have a certain size that depends on the distance to the object is defined as an elliptic model 19 as shown in FIG. 8.

Eyes are extracted in step ST45 by detecting the eyes within the elliptic model 19 defined as described earlier by using a circular edge extracting filter. An eye search area 19a having a certain width (depending on the distance to the person) is defined according to a standard height of eyes as measured from the top of the head 18a, and the eyes are detected from this area.

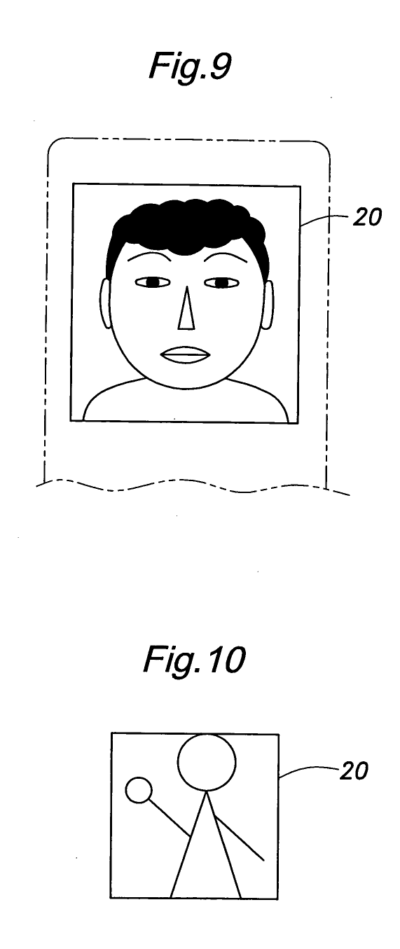

The face image is then cut out for transmission in step ST46. The size of the face image is selected in such a manner that the face image substantially entirely fills up the frame as illustrated in FIG. 9 particularly when the recipient of the transmission consists of a terminal such as a portable terminal 14 having a relatively small screen. Conversely, when the display consists of a large screen, the background may also be shown on the screen. The zooming in and out of the face image may be carried out according to the space between the two eyes that is computed from the positions of the eyes detected in step ST45. When the face image occupies the substantially entire area of the cut out image 20, the image may be cut out in such a manner that the mid point between the two eyes is located at a prescribed location for instance slightly above the central point of the cut out image. The subroutine for the face extracting process is then concluded.

The face database stored in the face database unit 9 is looked up in step ST8. When a matching face is detected, for instance, the name included in the personal information associated with the matched face is forwarded to the human response management unit 7 along with the face image itself.

Information on the person whose face was extracted in step ST7 is collected in step ST9. The information can be collected by using pattern recognition techniques, identification techniques and facial expression recognition techniques.

The position of the hands of the recognized person is determined in step ST10. The position of the hand can be determined in relation with the position of the face or searching the skin color area defined inside the outline extracted in step ST5. In other words, the outline cover the head and body of the person, and skin color areas other than the face can be considered as hands because only the face and hands are normally exposed.

The gesture and posture of the person are recognized in step ST1 1. The gesture as used herein may include any body movement such as waving a hand and beckoning some one by moving a hand that can be detected by considering the positional relationship between the face and hand. The posture may consist of any bodily posture that indicates that the person is looking at the robot. Even when a face was not detected in step ST7, the program flow advances to step ST10.

A response to the detected person is made in step ST12. The response may include speaking to the detected person and directing a camera and/or microphone toward the detected person by moving toward the detected person or turning the head of the robot toward the detected person. The image of the detected person that has been extracted in the steps up to step ST12 is compressed for the convenience of handling, and an image converted into a format that suits the recipient of the transmission is transmitted. The state variables of the mobile robot 1 detected by the robot state monitoring unit 6 may be superimposed on the image. Thereby, the position and speed of the mobile robot 1 can be readily determined simply looking at the display, and the operator of the robot can easily know the state of the robot from a portable remote terminal.

By thus allowing a person to be extracted by the mobile robot 1 and the image of the person acquired by the mobile robot 1 to be received by a portable remote terminal 14 via public cellular phone lines, the operator can view the surrounding scene and person from a view point of a mobile robot at will. For instance, when a long line of people has been formed in an event hall, the robot may entertain people who are bored from waiting. The robot may also chat with one of them, and this scene may be shown on a large display on the wall so that a large number of people may view it. If the robot 1 carries a camera 15, the image acquired by the camera may be transmitted for display on the monitor of a portable remote terminal or a large screen on the wall.

When a face was not detected in step ST7, the robot approaches what appears to be a human according to the gesture or posture analyzed in step ST11, and determines an object closest to the robot from those that appear to have waved a hand or otherwise demonstrated gesture or posture indicative of being a person. The captured image is then cut out so as to fill the designated display area 20 as shown in FIG. 10, and this cut out image is transmitted. In this case, the size is adjusted in such a manner that the vertical length or lateral width, whichever is greater, of the outline of the object fits into the designated area 20 for the cut out image.

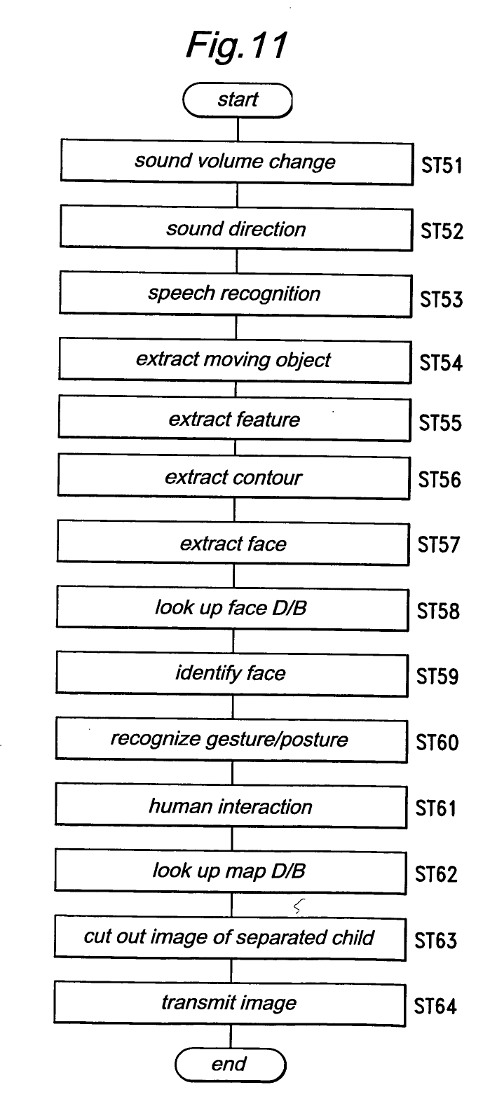

The mobile robot may be used for looking after children who are separated from their parents in places such as event halls where a large number of people congregate. The control flow of an exemplary task of looking after such a separated child is shown in the flowchart of FIG. 11. The overall flow may be generally based on the control flow illustrated in FIG. 2, and only a part of the control flow that is different from the control flow of FIG. 2 is described in the following.

At the entrance to the event hall, a fixed camera takes a picture of the face of each child, and this image is transmitted to the mobile robot 1. The mobile robot 1 receives this image by using a wireless receiver not shown in the drawing, and the human response managing unit 7 registers this data in the face database unit 9. If the parent of the child has a portable terminal equipped with a camera, the telephone number of this portable terminal is also registered.

Similarly as in steps ST21 to ST23, the change in the sound volume and direction to the sound source are detected, and the detected speech is recognized in steps ST51 to 53. The crying of a child may be recognized in step ST53 as a special item of the vocabulary. A moving object is detected in step ST54 similarly as in step ST5. Even when a crying of a child is not detected in step ST53, the program flow advances to step ST54. Even when a moving object is not extracted in step ST54, the program flow advances to step ST55.

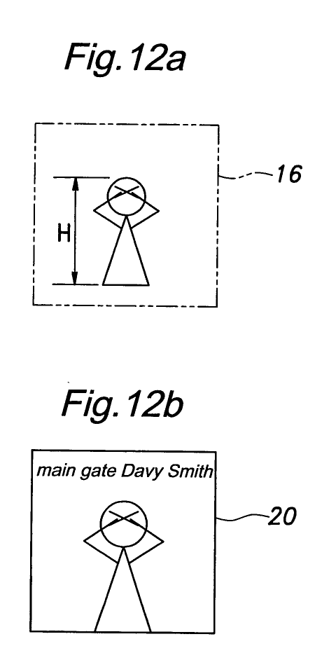

Various features are extracted in step ST55 similarly as in step ST33, and an outline is extracted in step ST56 similarly as in step ST34. A face is extracted in step ST57 similarly as in step ST7. In this manner, a series of steps from the detection of a skin color to the cutting out of a face image are executed similarly as in steps ST43 to 46. During the process of extracting an outline and a face, the height of the detected person (H in FIG. 12a) is computed from the distance to the object, position of the head and direction of the camera 2a, and determines if it is in fact a child (for instance when the height is less than 120 cm).

The face database is looked up in step ST58 similarly as in step ST8, and the extracted person is compared with the registered faces in step ST59 before the control flow advances to step ST60. Even when the person cannot be identified with any of the registered faces, the program flow advances to step ST60.

The gesture/posture of the detected person is recognized in step ST60 similarly as in step ST11. As illustrated in FIG. 12a, when it is detected that the palm of a hand is moved near the face from the information on the outline and skin color, it can be recognized as a gesture. Other states of the person may be recognized as different postures.

A human response process is conducted in step ST61 similarly as in step ST12. In this case, the mobile robot 1 moves toward the person who appears to be a child separated from its parent and directs the camera toward it by turning the face of the robot toward it. The robot then speaks to the child in an appropriate fashion. For instance, the robot may say to the child, “Are you all right?” Particularly when the individual person was identified in step ST59, the robot may say the name of the person. The current position is then identified by looking up the map database in step 62 similarly as in step ST6.

The image of the separated child is cut out in step ST63 as illustrated in FIG. 12b. This process can be carried out as in steps ST41 to 46. Because the clothes of the separated child may help identify it, the size of the cut out image may be selected such that the entire torso of the child from the waist up may be shown in the screen.

The cut out image is then transmitted in step ST64 similarly as in step ST13. The current position information and individual identification information (name) may also be attached to the transmitted image of the separated child. If the face cannot be found in the face database and the name of the separated child cannot be identified, only the current position is attached to the transmitted image. If the identity of the child can be determined and the telephone number of the remote terminal of the parent is registered, the face image may be transmitted to this remote terminal directly. Thereby, the parent can visually identify his or her child, and can meet it according to the current position information. If the identity of the child cannot be determined, it may be shown on a large screen for the parent to see.

Although the present invention has been described in terms of preferred embodiments thereof, it is obvious to a person skilled in the art that various alterations and modifications are possible without departing from the scope of the present invention which is set forth in the appended claims.

1. An image transmission system for a mobile robot, comprising:
a camera for capturing an image as an image signal;
human detecting means for detecting a human from the captured image;
a power drive unit for moving the robot toward the detected human;
face identifying means for identifying a position of a face of the detected human;
face image cut out means for cutting out a face image from the captured image of the detected human; and
image transmitting means for transmitting the cut out face image to an external terminal.

2. An image transmission system according to claim 1, further comprising means for monitoring state variables including a current position of the robot; the image transmitting means transmitting the monitored state variables in addition to the cut out face image.

3. An image transmission system according to claim 1, wherein the robot is adapted to direct the camera toward the position of the face of the detected human.

4. An image transmission system according to claim 1, further comprising means for measuring a distance to each of a plurality of humans, the human detecting means being provided with means for detecting a human closest to the robot.

5. An image transmission system according to claim 1, wherein the mobile robot is adapted to move toward the detected human according to a distance to the detected human.

6. An image transmission system according to claim 1, further comprising a face database that stores images of a plurality of faces and face identifying means for comparing the cut out face image with the faces stored in the face database to identify the cut out face image.

7. An image transmission system according to claim 1, wherein the face identifying means comprises means for detecting an outline of the detected human, and identifying a face as an area defined under an upper part of the outline of the detected human.

8. An image transmission system according to claim 1, wherein the human detecting means is adapted to detect a human as a moving object that changes in position from one frame of the image to another.
